(19) United States
(12) Patent Application Publication
(10) Pub. No.: US 2013/0069887 A1
(43) Pub. Date: Mar. 21, 2013

(54) STRUCTURE OF A TOUCH PANEL AND A MANUFACTURING METHOD THEREOF

(71) Applicants: Yuh-Wen LEE, Zhubei (TW); Keming Ruan, Ningde (CN); Fengming Lin, Fuzhou (CN)

(72) Inventors: Yuh-Wen LEE, Zhubei (TW); Keming Ruan, Ningde (CN); Fengming Lin, Fuzhou (CN)

(21) Appl. No.: 13/462,838

(22) Filed: May 3, 2012

(30) Foreign Application Priority Data
Sep. 21, 2011 (CN) 201110289620.8

(51) Int. Cl. G06F 3/041; H01H 11/00

(52) U.S. Cl. 345/173; 29/622

(57) ABSTRACT

The present disclosure relates to a touch technology, and more particularly to structure of a touch panel and a manufacturing method thereof. The structure of the touch panel comprises: a sensing layer; and a plurality of surrounding circuits that are disposed in surrounding area of the sensing layer. The surrounding circuits are connected to the sensing layer, wherein the surrounding circuits are made of a transparent conductive material. The transparent conductive material provides good conductivity and reduces visibility of the surrounding circuits, and thus the requirement for a transparent touch panel is met.

### BACKGROUND OF THE INVENTION

This Application claims the benefit of the People's Republic of China Application No.201110289620.8, filed on Sep. 21, 2011.

### FIELD OF THE INVENTION

The present disclosure relates to a touch technology, and more particularly relates to structure of a touch panel and a manufacturing method thereof.

### DESCRIPTION OF THE RELATED ART

Touch panels have been widely used in work and life. Usually, a touch panel has a sensing area on surface of a substrate; wherein the sensing area is used for sensing a finger of a human body or a writing tool similar to a pen to facilitate the touch. According to different principles, touch panels can be classified into resistive type, capacitive type, infrared type and surface acoustic wave type, etc.

For a conventional capacitive touch panel, a plurality of transparent electrodes are mutually insulated, interlaced, and disposed on a surface of a substrate, wherein the transparent electrodes are connected to a controller by surrounding circuits. When a touch object gets close to or touches the touch panel, a change of capacitance occurs between the electrodes in the touch location, after which the capacitance change signals are transmitted to the controller via the surrounding circuits. Thus, coordinates of the touch location can be determined by calculating the change in the capacitance signals.

In a conventional capacitive touch panel, due to good conductivity and low price of metal conductor, the surrounding circuits are generally made of metal wires. A metal wire has high reflectivity and a certain width, and therefore it is comparatively easy to see the surrounding circuits from an appearance of the touch panel. This appearance of the surrounding circuits with naked eyes fails to meet the requirement for a transparent touch panel and leads to an appearance defect of the touch panel. Moreover, the problem that the surrounding circuits are visible exists not only in capacitive touch panels but also in resistive touch panels, infrared touch panels, and a surface acoustic wave touch panels, among other known panels.

### SUMMARY OF THE INVENTION

The present disclosure provides structure of a touch panel and a manufacturing method thereof, wherein surrounding circuits are made of a transparent conductive material. Due to good transparency and conductivity, the transparent conductive material can provide good conductivity and reduce visibility of the surrounding circuits, thereby meeting the requirement for a transparent touch panel.

The present disclosure provides structure of a touch panel, comprising: a sensing layer; and a plurality of surrounding circuits disposed in the surrounding area of the sensing layer. The plurality of surrounding circuits is connected to the sensing layer, wherein the surrounding circuits are made of a transparent conductive material.

According to the structure of the touch panel of the present disclosure, the sensing layer comprises first sensing electrodes disposed along a first axis and second sensing electrodes disposed along a second axis; and an insulation layer disposed between the first sensing electrodes and the second sensing electrodes.

According to the structure of the touch panel of the present disclosure, the first sensing electrodes comprise of a plurality of first conductive units and a plurality of first conductive wires, which connect the first conductive units. Similarly, the second sensing electrodes comprise of a plurality of second conductive units and a plurality of second conductive wires which connect the second conductive units.

According to the structure of the touch panel of the present disclosure, the insulation layer comprises of a plurality of insulation blocks, wherein each insulation block is disposed between the first conductive wire and the second conductive wire.

According to the structure of the touch panel of the present disclosure, the first conductive units, the second conductive units and the first conductive wires are made of a transparent conductive material.

According to the structure of the touch panel of the present disclosure, the first conductive units, the second conductive units, the first conductive wires and the second conductive wires are made of a transparent conductive material.

According to the structure of the touch panel of the present disclosure, the transparent conductive material is selected from a group comprising conductive polymer, metal reticular film, silver nanoparticle, silver nanowire, carbon nanotube, or a combination thereof.

According to the structure of the touch panel of the present disclosure, the conductive polymer is selected from a group comprising polyacetylene, polythiophene, polypyrrole, polyaniline, polyphenylene, poly phenylene vinylene (PPV), polydiacetylene, or a combination thereof.

According to the structure of the touch panel of the present disclosure, the insulation layer is made of a transparent insulating material.

The present disclosure also provides a method of manufacturing a touch panel, comprising: forming a sensing layer; forming a plurality of surrounding circuits disposed in surrounding area of the sensing layer, wherein the surrounding circuits are connected to the sensing layer, further wherein the surrounding circuits are made of a transparent conductive material.

According to the method of manufacturing the touch panel in the present disclosure, the step of forming a sensing layer comprises: disposing first sensing electrodes along a first axis; disposing second sensing electrodes along a second axis; and disposing an insulation layer between the first sensing electrodes and the second sensing electrodes.

According to the method of manufacturing the touch panel in the present disclosure, the first sensing electrodes comprise a plurality of first conductive units and a plurality of first conductive wires, which connect the first conductive units; and the second sensing electrodes comprise of a plurality of second conductive units and a plurality of second conductive wires which connect the second conductive units, and the insulation layer comprises a plurality of insulation blocks, and wherein each insulation block is disposed between the first conductive wire and the second conductive wire.

According to the method of manufacturing the touch panel in the present disclosure, the first conductive units, the second conductive units, the first conductive wires, and the surrounding circuits are formed simultaneously; an insulation block is disposed on surface of each first conductive wire; and the second conductive wires are disposed on surface of the insulation block, wherein the first conductive units, the second conductive units, and the first conductive wires are made of a transparent conductive material.

According to the method of manufacturing the touch panel in the present disclosure, the first conductive units, the second conductive units and the first conductive wires are simultaneously disposed on the substrate; an insulation block is disposed on surface of each first conductive wire; the second conductive wires are disposed on surface of the insulation block; and the surrounding circuits, which are connected to the first conductive units and the second conductive units, are disposed simultaneously; wherein the first conductive units, the second conductive units, the first conductive wires, and the second conductive wires are made of a transparent conductive material.

According to the method of manufacturing the touch panel in the present disclosure, the transparent conductive material is selected from a group comprising conductive polymer, metal reticular film, silver nanoparticle, silver nanowire, carbon nanotube, or a combination thereof.

According to the method of manufacturing the touch panel in the present disclosure, the conductive polymer is selected from a group comprising polyacetylene, polythiophene, polypyrrole, polyaniline, polyphenylene, poly phenylene vinylene (PPV), polydiacetylene, or a combination thereof.

For the structure of the touch panel and the manufacturing method provided in the present disclosure, the surrounding circuits are made of a transparent conductive material. Due to good transparency and conductivity, the transparent conductive material can provide good conductivity and reduce visibility of the surrounding circuits, and thus the requirement for a transparent touch panel is met.

### BRIEF DESCRIPTION OF THE DRAWINGS

For those skilled in the art, embodiments combined with drawings, described below are for illustration purpose only and do not limit the scope of the present disclosure in any manner.

FIG. 1 is a schematic plan view of a structure of a touch panel in accordance with the present disclosure;

FIG. 2 is a schematic sectional view of the structure of the touch panel shown in FIG. 1;

FIG. 3 is a schematic view of a first process of manufacturing the touch panel in accordance with a first embodiment of the present disclosure;

FIG. 4 is a schematic view of a second process of manufacturing the touch panel in accordance with the first embodiment of the present disclosure;

FIG. 5 is a schematic view of a first process of manufacturing a touch panel in accordance with a second embodiment of the present disclosure; and

FIG. 6 is a schematic view of a second process of manufacturing the touch panel in accordance with the second embodiment of the present disclosure.

### DETAILED DESCRIPTION OF THE EMBODIMENTS

In the following embodiments, capacitive touch panel technology is taken merely as an example. However, the spirit and scope of the present disclosure can be extended to any other touch panel technologies including but not limited to resistive type, infrared type, and surface acoustic wave type.

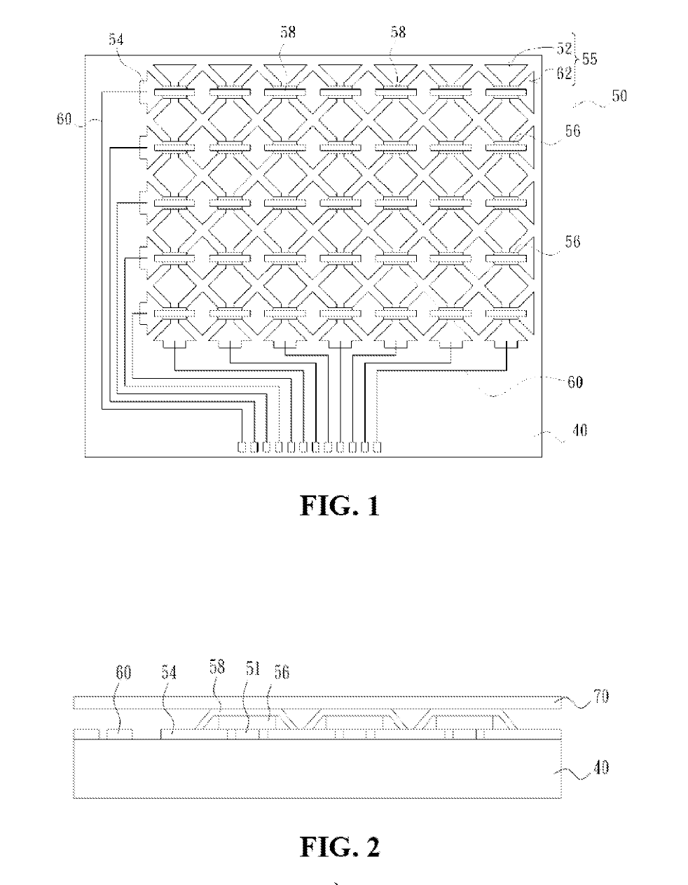

FIG. 1 is a schematic plan view of a structure of a touch panel 50 in accordance with the present disclosure. A touch panel 50 comprises a sensing layer 55 and a plurality of surrounding circuits 60, wherein the sensing layer 55 is used for sensing touch operation and generating sensing signals and the plurality of surrounding circuits 60 are disposed in the surrounding area of the sensing layer 55 and connected to the sensing layer 55. The plurality of surrounding circuits 60 is used for transmitting the sensing signals to a controller for calculating so as to determine coordinates of touch location, wherein the plurality of surrounding circuits are made of a transparent conductive material.

FIG. 2 is a schematic sectional view of the touch panel shown in FIG. 1. Referring to FIG. 1 and FIG. 2, in the present embodiment, the sensing layer 55 comprises first sensing electrodes 52 disposed along a first axis, second sensing electrodes 62 disposed along a second axis, and an insulation layer that is disposed between the first sensing electrodes 52 and the second sensing electrodes 62. The first sensing electrodes 52 comprise of a plurality of first conductive units 53 and a plurality of first conductive wires 51, which connect the first conductive units 53. The second sensing electrodes 62 comprise of a plurality of second conductive units 54 and a plurality of second conductive wires 58, which connect the second conductive units 54. The insulation layer comprises of a plurality of insulation blocks 56, wherein each insulation block 56 is disposed between the first conductive wire 51 and the second conductive wire 58. In a preferred embodiment, insulation blocks 56 are made of a transparent insulating material.

The surrounding circuits 60 are connected to the first sensing electrodes 52 and the second sensing electrodes 62 so that the surrounding circuits 60 can transmit change in capacitance of the first sensing electrodes 52 and the second sensing electrodes 62 caused by touching to a controller (not shown) for determining coordinates of touch location.

In the above touch panel structure, the first conductive units 53, the second conductive units 54, and the surrounding circuits 60 are made of a transparent conductive material while the second conductive wires 58 are made of a transparent conductive material which is same or different from that of the surrounding circuits 60. Illustratively, the second conductive wires 58 are made of Indium tin oxide (ITO), or any other metal material, wherein size of each second conductive wire 58 are comparatively small, and therefore visual effect of the panel appearance is not affected.

The transparent conductive material can be one or more of a conductive polymer, metal reticular film, silver nanoparticle, silver nanowire or carbon nanotube, etc. The conductive polymer can be polyacetylene, polythiophene, polypyrrole, polyaniline, polyphenylene, poly (phenylene vinylene) (PPV), and polydiacetylene. The conductive polymer not only has good conductivity and transparency but also has stable chemical characteristics, with the help of which the polymer cannot be easily eroded by external environment.

The touch panel 50 further comprises a substrate 40 and a surface protection layer 70. The sensing layer 55 is disposed on the substrate 40, wherein the substrate 40 can be a transparent glass substrate or a plastic substrate. The substrate includes but not limited to polyethylene terephthalate (PET), poly carbonate (PC), polyethylene (PE) or polymethylmethacrylate (PMMA). The surface protection layer 70 is formed above the sensing layer 55, wherein the surrounding circuits 60 and the surface protection layer 70 are made of a transparent insulating material.

The surrounding circuits 60 of the touch panel 50 are made of a transparent conductive material. Due to good transparency and conductivity, the transparent conductive material can provide good conductivity and reduce visibility of the surrounding circuits 60.

Moreover, the first sensing electrodes 52 and the second sensing electrodes 62 formed on the transparent substrate 40 are made of a transparent conductive material. The insulation blocks 56 and the surface protection layer 70 are made of a transparent insulating material such that the structure of the touch panel 50 in the present disclosure can meet the requirement of a completely transparent touch panel.

The touch panel 50 can be manufactured by using a manufacturing method provided in the present disclosure. The method comprises: forming a sensing layer 55; forming a plurality of surrounding circuits 60, which are disposed in surrounding area of the sensing layer 55 and are connected to the sensing layer 55, wherein the surrounding circuits 60 are made of a transparent conductive material.

Detailed process of manufacturing the touch panel 50 will be described combined with the drawings as follows.

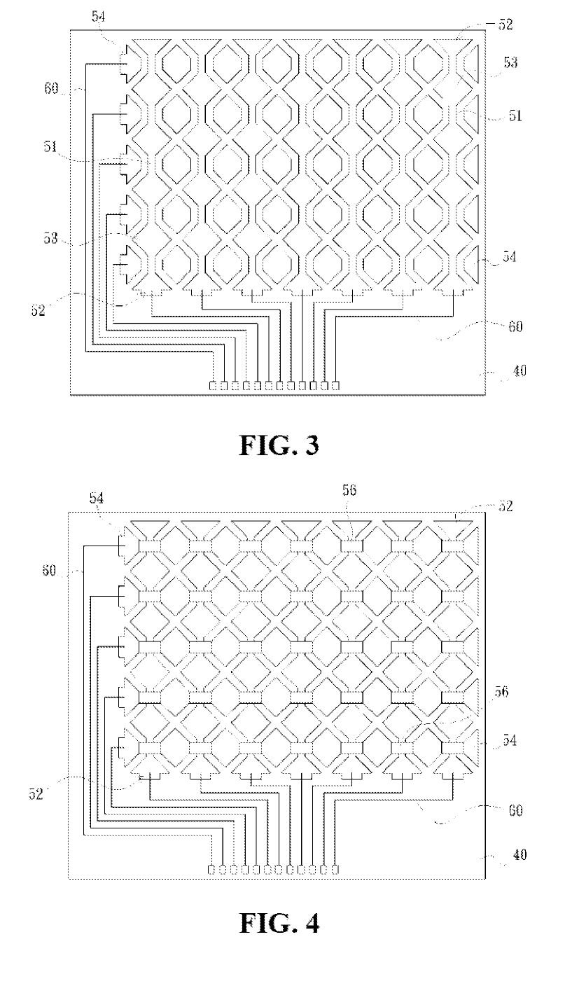

FIG. 3 is a schematic view of the first process of manufacturing a touch panel in accordance with the first embodiment of the present disclosure. The first step comprises: using a transparent conductive material to simultaneously form a plurality of first conductive units 53 along a first axis, a plurality of second conductive units 54 along a second axis, a plurality of first conductive wires 51, and a plurality of surrounding circuits 60 on a substrate 40 by sputtering, etching or other techniques. First, after the first conductive wires 51 electrically connect the adjacent first conductive units 53, sensing electrodes 52 are formed along a first axis. The plurality of surrounding circuits 60 are electrically connected to the first sensing electrodes 52. However, according to another preferred embodiment, first, a plurality of first conductive units 53 along a first axis, a plurality of second conductive units 54 along a second axis, and a plurality of first conductive wires 51 can be formed, and then a plurality of surrounding circuits 60 can be formed, and vice versa.

FIG. 4 is a schematic view of the second step of manufacturing a touch panel in accordance with the first embodiment of the present disclosure. The second step comprises: using a transparent insulating material to form a plurality of insulation blocks 56 across surfaces of the first conductive wires 51.

The third step comprises: using a transparent conductive material which is same or different from that of the surrounding circuits 60 to form a plurality of second conductive wires 58 by sputtering, etching or any other technique. Illustratively, the second conductive wires 58 can be made of ITO, or any other metal material. Since the size of each second conductive wire 58 is small, visual effect of the product appearance is not affected, as shown in FIG. 1. The second conductive wires 58 are formed on the insulation blocks 56. The second sensing electrodes 62 are formed by the second conductive wires 58 electrically connecting the adjacent second conductive units 54. The surrounding circuits 60 are electrically connected to the second sensing electrodes 62 and the insulation blocks 56 are used for separating the second conductive wires 58 from the first conductive wires 51.

The surrounding circuits 60, disposed on the substrate 40, electrically connect the first sensing electrodes 52 and the second sensing electrodes 62. The surrounding circuits 60 transmit changes in capacitance of the first sensing electrodes 52 and the second sensing electrodes 62 to a controller (not shown).

The transparent conductive material used for the first conductive units 53, the second conductive units 54, the first conductive wires 51, and the surrounding circuits 60 includes but is not limited to conductive polymer, metal reticular film, silver nanoparticle, silver nanowire or carbon nanotube, etc. The conductive polymer includes polyacetylene, polythiophene, polypyrrole, polyaniline, polyphenylene, poly (phenylene vinylene) (PPV) or polydiacetylene, etc. The conductive polymer not only has good conductivity and transparency but also has a stable chemical characteristic, which cannot be easily eroded by external environment.

The fourth step comprises: using a transparent insulating material to form a surface protection layer 70 above the substrate 40, the first sensing electrodes 52, the second sensing electrodes 62, and the surrounding circuits 60, as shown in FIG. 2. After completing the above-mentioned four steps, structure of the touch panel 50 shown in FIG. 1 and FIG. 2 can be completed.

Next, the process of manufacturing a touch panel 50 in accordance with the second embodiment of the present disclosure is described.

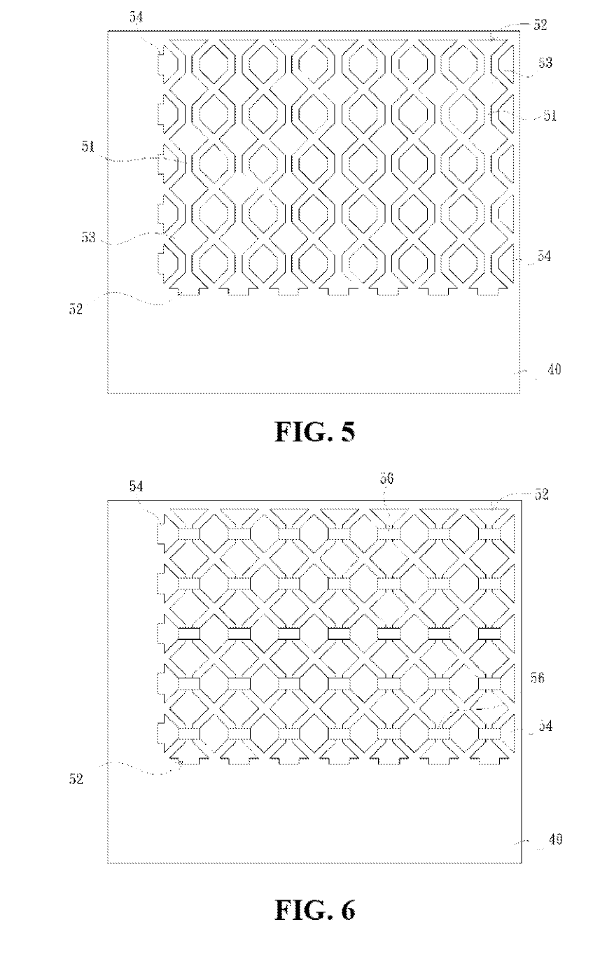

FIG. 5 is a schematic view of the first step of manufacturing a touch panel in accordance with the second embodiment of the present disclosure. The first step comprises: using a transparent conductive material to form a plurality of first conductive units 53 along a first axis, a plurality of second conductive units 54 along a second axis, and a plurality of first conductive wires 51 on a substrate 40 by sputtering, etching or any other technique. First sensing electrodes 52 are formed along the first axis after the first conductive wires 51 electrically connect the adjacent first conductive units 53.

FIG. 6 is a schematic view of the second step of manufacturing the touch panel in accordance with the second embodiment of the present disclosure. The second step comprises: using a transparent insulating material to form a plurality of insulation blocks 56 across surfaces of the first conductive wires 51.

The third step comprises: using a transparent conductive material to simultaneously form a plurality of second conductive wires 58 and a plurality of surrounding circuits 60 by sputtering, etching or any other technique, as shown in FIG. 1. The second conductive wires 58 are formed on the insulation blocks 56, wherein the second sensing electrodes 62 are formed by the second conductive wires 58 electrically connecting the adjacent second conductive units 54. The surrounding circuits 60 are electrically connected to the first sensing electrodes 52 and the second sensing electrodes 62. The insulation blocks 56 are used for separating the second conductive wires 58 from the first conductive wires 51.

The transparent conductive material used for the first conductive units 53, the second conductive units 54, the first conductive wires 51, the second conductive wires 58 and the surrounding circuits 60 includes but not limited to conductive polymer, metal reticular film, silver nanoparticle, silver nanowire or carbon nanotube, etc. The conductive polymer includes polyacetylene, polythiophene, polypprole, polyaniline, polyphenylene, poly (phenylene vinylene) (PPV) or polydiacetylene, etc. The conductive polymer not only has good conductivity and transparency but also has stable chemical characteristic, which cannot be easily eroded by external environment.

The fourth step comprises: using a transparent insulating material to form a surface protection layer 70 above the substrate 40, the first sensing electrodes 52, the second sensing electrodes 62, and the surrounding circuits 60, as shown in FIG. 2. After completing the above four steps, structure of the touch panel 50 as shown in FIG. 1 and FIG. 2 can be achieved.

As mentioned in the first and second embodiments, the surrounding circuits 60 can be made of a transparent conductive material; wherein the transparent conductive material provides good conductivity and reduces visibility of the surrounding circuits 60.

Moreover, the first sensing electrodes 52, the second sensing electrodes 62, and the surrounding circuits 60 formed on the transparent substrate 40 are made of a transparent conductive material, and the insulation blocks 56 and the surface protection layer 70 are made of a transparent insulating material such that structure of the touch panel 50 in the present disclosure can meet the requirement for a completely transparent touch panel.

While certain embodiments have been shown and described, various modifications and substitutions may be made thereto without departing from the spirit and scope of the disclosure. Therefore, it is to be understood that the present disclosure has been described by way of illustration and not limitations.

What is claimed is:

1. A structure of a touch panel, comprising:
a sensing layer; and
a plurality of surrounding circuits disposed in surrounding area of the sensing layer and connected to the sensing layer, wherein the plurality of surrounding circuits are made of a transparent conductive material.

2. The structure of the touch panel of claim 1, wherein the sensing layer comprises first sensing electrodes disposed along a first axis, second sensing electrodes disposed along a second axis, and an insulation layer disposed between the first sensing electrodes and the second sensing electrodes.

3. The structure of the touch panel of claim 2, wherein the first sensing electrodes comprise a plurality of first conductive units and a plurality of first conductive wires that connect the first conductive units, and the second sensing electrodes comprise a plurality of second conductive units and a plurality of second conductive wires that connect the second conductive units.

4. The structure of the touch panel of claim 3, wherein the insulation layer comprises a plurality of insulation blocks, wherein each insulation block is disposed between the first conductive wire and the second conductive wire.

5. The structure of the touch panel of claim 4, wherein the first conductive units, the second conductive units, and the first conductive wires are made of a transparent conductive material.

6. The structure of the touch panel of claim 4, wherein the first conductive units, the second conductive units, the first conductive wires, and the second conductive wires are made of a transparent conductive material.

7. The structure of the touch panel of claim 1, wherein the transparent conductive material is selected from a group comprising conductive polymer, metal reticular film, silver nanoparticle, silver nanowire, carbon nanotube, or a combination thereof.

8. The structure of the touch panel of claim 7, wherein the conductive polymer is selected from a group comprising of polyacetylene, polythiophene, polypyrrole, polyaniline, polyphenylene, poly phenylene vinylene (PPV), polydiacetylene or a combination thereof.

9. The structure of the touch panel of claim 2, wherein the insulation layer is made of a transparent insulating material.

10. A method of manufacturing a touch panel, comprising:
forming a sensing layer; and
forming a plurality of surrounding circuits disposed in surrounding area of the sensing layer, wherein the surrounding circuits are connected to the sensing layer, and wherein the surrounding circuits are made of a transparent conductive material.

11. The method of manufacturing the touch panel of claim 10, wherein the step of forming a sensing layer comprises:
disposing first sensing electrodes along a first axis;
disposing second sensing electrodes along a second axis; and
disposing an insulation layer between the first sensing electrodes and the second sensing electrodes.

12. The method of manufacturing the touch panel of claim 11, wherein the first sensing electrodes comprise a plurality of first conductive units and a plurality of first conductive wires that connect the first conductive units, the second sensing electrodes comprise a plurality of second conductive units and a plurality of second conductive wires which connect the second conductive units, and the insulation layer comprises a plurality of insulation blocks, and wherein each insulation block is disposed between the first conductive wire and the second conductive wire.

13. The method of manufacturing the touch panel of claim 12, wherein the first conductive units, the second conductive units, the first conductive wires, and the surrounding circuits are formed simultaneously, and wherein an insulation block is disposed on surface of each first conductive wire, and wherein the second conductive wires are disposed on surface of the insulation block, wherein the first conductive units, the second conductive units, and the first conductive wires are made of a transparent conductive material.

14. The method of manufacturing the touch panel of claim 12, wherein the first conductive units, the second conductive units, and the first conductive wires are simultaneously disposed on a substrate, and wherein an insulation block is disposed on surface of each first conductive wire, and wherein the second conductive wires are disposed on surface of the insulation block, and wherein the surrounding circuits which are connected to the first conductive units and the second conductive units are disposed simultaneously, and wherein the first conductive units, the second conductive units, the first conductive wires, and the second conductive wires are made of a transparent conductive material.

15. The method of manufacturing the touch panel of claim 10, wherein the transparent conductive material is selected from a group comprising conductive polymer, metal reticular film, silver nanoparticle, silver nanowire, carbon nanotube, or a combination thereof.

16. The method of manufacturing the touch panel of claim 15, wherein the conductive polymer is selected from a group comprising of polyacetylene, polythiophene, polypyrrole, polyaniline, polyphenylene, poly phenylene vinylene (PPV), polydiacetylene, or a combination thereof.
